(19) United States
(12) Patent Application Publication
(10) Pub. No.: US 2011/0174753 A1
(43) Pub. Date: Jul. 21, 2011

(54) STACKABLE TRANSPORT SYSTEM

(76) Inventors: Matthew Pinto, Kalamazoo, MI (US); David Pinto, Kalamazoo, MI (US)

(21) Appl. No.: 12/689,037

(22) Filed: Jan. 18, 2010

(51) Int. Cl. A47F 5/00; F16M 13/00

(52) U.S. Cl. 211/153; 248/201

(57) ABSTRACT

The present disclosure therefore provides a stackable transport frame for transporting items. The transport frame includes a plurality of stackable tiers, wherein each of the tiers has a pair of support tracks disposed in spaced parallel relation with each other and are fixedly coupled by a plurality of track supports disposed substantially transversely to the longitudinal length of the support tracks. A plurality of coupling platforms are fixedly attached proximate an end of each support track of each of the stackable tiers, such that each of the coupling platforms is disposed at a corner of each of the stackable tiers. Each of the coupling platforms also has a pair of opposed couplings extending perpendicularly upwardly and downwardly relative to the plane of the stackable tier to which the coupling platform is attached. Each of the couplings is adapted to securely receive one of the plurality of detachable vertical support members so as to detachably lock one of the plurality of vertical support members to the coupling platform in a perpendicular relation to the plane of the stackable tier, wherein one of the plurality of stackable tiers is stacked upon another of the plurality of stackable tiers to form a lower tier and an upper tier. The lower tier has one end of one of the plurality of vertical support members locked to each of the upwardly extending couplings of the coupling platforms of the lower pier, and the upper tier has an opposite end of each one of the plurality of vertical support members locked to each of the downwardly extending couplings of the coupling platforms of the upper tier at each respective corner of the stackable tiers.

### FIELD OF THE INVENTION

The present invention generally relates to a stackable transport frame for transporting items, particularly a frame for transporting bulky items, such as hospital stretchers.

### BACKGROUND OF THE INVENTION

It is often times necessary to transport bulky, fabricated products from their point of manufacture to their point of distribution and/or end use service. Such items can include, for example, hospital stretchers, which are complicated mechanical and electrical devices typically found and used in hospitals. Such stretchers, sometimes costing thousands of dollars apiece, often are provided with sophisticated mechanical systems that allow them to be used in a hospital environment, as well as various electrical devices that raise, lower, tilt, and perform other functions necessary to the convenient assistance of patients.

Such hospital stretchers are constructed by a variety of manufacturers, and of course, after manufacture, must be safely delivered to their point of distribution and ultimately to their in-use customer. As for such expensive, bulky items, it is necessary, therefore, to safeguard them during transportation. Such safeguards include protection from collision with other objects, as well as a method by which to contain them securely within an environment that is safe from damage. Thus, a secure and robust transport system is desired for the distribution and transport of bulky, expensive items, such as hospital stretchers.

### SUMMARY OF THE INVENTION

The present disclosure therefore provides a stackable transport frame for transporting items. The transport frame includes a plurality of stackable tiers, wherein each of the tiers has a pair of support tracks disposed in spaced parallel relation with each other and are fixedly coupled by a plurality of track supports disposed substantially transversely to the longitudinal length of the support tracks. A plurality of coupling platforms are fixedly attached proximate an end of each support track of each of the stackable tiers, such that each of the coupling platforms is disposed at a corner of each of the stackable tiers. Each of the coupling platforms also has a pair of opposed couplings extending perpendicularly upwardly and downwardly relative to the plane of the stackable tier to which the coupling platform is attached. Each of the couplings is adapted to securely receive one of the plurality of detachable vertical support members so as to detachably lock one of the plurality of vertical support members to the coupling platform in a perpendicular relation to the plane of the stackable tier, wherein one of the plurality of stackable tiers is stacked upon another of the plurality of stackable tiers to form a lower tier and an upper tier. The lower tier has one end of one of the plurality of vertical support members locked to each of the upwardly extending couplings of the coupling platforms of the lower pier, and the upper tier has an opposite end of each one of the plurality of vertical support members locked to each of the downwardly extending couplings of the coupling platforms of the upper tier at each respective corner of the stackable tiers.

An additional feature of the present disclosure is a transport frame for transporting items having an upper stackable tier and a lower stackable tier, each tier having a pair of support tracks disposed in spaced parallel relation with each other and coupled by a plurality of track supports attached substantially transversely to the longitudinal length of the support tracks. A coupling platform is fixedly attached proximate an end of each support track of each of the stackable tiers to form a corner of each of the stackable tiers. The coupling platforms have a pair of opposed couplings extending perpendicularly upwardly and downwardly relative to the plane of the stackable tier to which the coupling platform is attached. Vertical support members extend intermediate the corners of each of the upper and lower stackable tiers and the support members are detachably locked to one of the coupling platforms in a perpendicular relation to the plane of the stackable tier, wherein one of the plurality of stackable tiers is stacked upon another of the plurality of stackable tiers to form a lower tier and an upper tier. The lower tier has one end of one of the plurality of vertical support members locked to each of the upwardly extending couplings of the coupling platforms of the lower pier, and the upper tier has an opposite end of a respective one of the plurality of vertical support members locked to each of the downwardly extending couplings of the coupling platforms of the upper tier at each respective corner of the stackable tiers.

A further feature of the present disclosure is a coupling platform for joining a plurality of stackable tiers, wherein each of the tiers includes a load bearing surface having an outer perimeter for carrying an item. A plurality of coupling platforms is fixedly attached about the outer perimeter of the load bearing surface of each of the stackable tiers. Each of the coupling platforms further includes a pair of opposed couplings extending perpendicularly upwardly and downwardly relative to the plane of the stackable tier to which the coupling platform is attached. A plurality of detachable vertical support member is also provided. Each of the couplings is adapted to securely receive one end of one of the plurality of detachable vertical support members so as to detachably lock one of the plurality of vertical support members to the coupling platform in a perpendicular relation to the plane of the stackable tier, wherein one of the plurality of stackable tiers is stacked upon another of the plurality of stackable tiers to form a lower tier and an upper tier. The lower tier has one end of the vertical support member locked to the upwardly extending coupling of the coupling platform of the lower tier, and the upper tier has an opposite end of one of the plurality of vertical support members locked to the downwardly extending coupling of the coupling platform of the upper tier.

Yet another feature of the present disclosure is a stackable transport frame for transporting items including an upper stackable tier and a lower stackable tier. A coupling platform is fixedly attached proximate an edge of each of the stackable tiers and further includes a pair of opposed couplings extending perpendicularly upwardly and downwardly relative to the plane of the stackable tier to which the coupling platform is attached. The opposed couplings each have an interior surface into which one of a plurality of vertical support members may be received, and the opposed couplings each have a coupling lock pivotably attached thereto having an interior surface matching the interior surface of the opposed couplings to create an opening into which one of the plurality of vertical support members is rigidly received. The vertical support members extend intermediate an outer perimeter of each of the upper and lower stackable tiers, and the vertical support members detachably lock to one of the coupling platforms in a perpendicular relation to the plane of the stackable tier. One of the plurality of stackable tiers is stacked upon another of the plurality of stackable tiers to form the lower tier and the upper tier. The lower tier has one end of one of the plurality of vertical support members locked to each of the upwardly extending couplings of the coupling platform of the lower tier, and the upper tier has an opposite end of one of the plurality of vertical support members locked to each of the downwardly extending couplings of the coupling platforms of the upper tier of the stackable tiers.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of a stackable transport frame of the present disclosure;

FIG. 2 is a perspective view of a coupling platform of the present disclosure with a detachable vertical support member clamped in place;

FIG. 3 is another perspective view of the coupling platform of the present disclosure;

FIG. 4 is still another perspective view of the coupling platform of the present disclosure;

FIG. 5 is a bottom view of a tier;

FIG. 6 is a perspective view of a rail and stop securing and receiving one of the detachable vertical support members; and

FIG. 7 is a perspective view of a ramp adaptable for use with the stackable transport frame of the present disclosure.

### DETAILED DESCRIPTION OF THE INVENTION

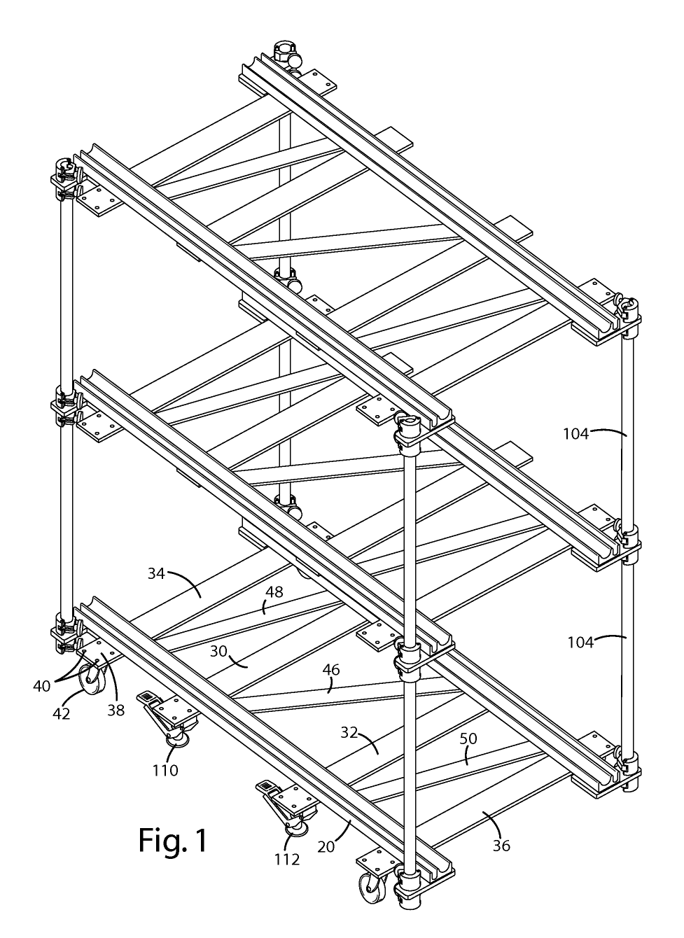

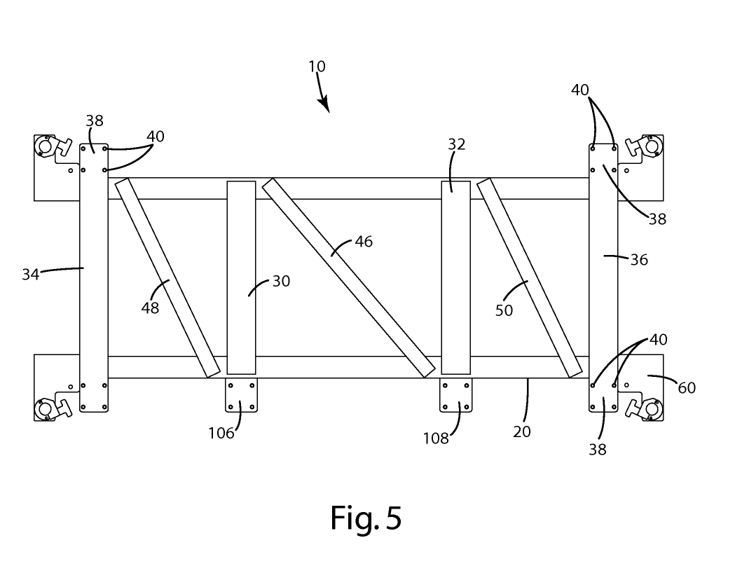

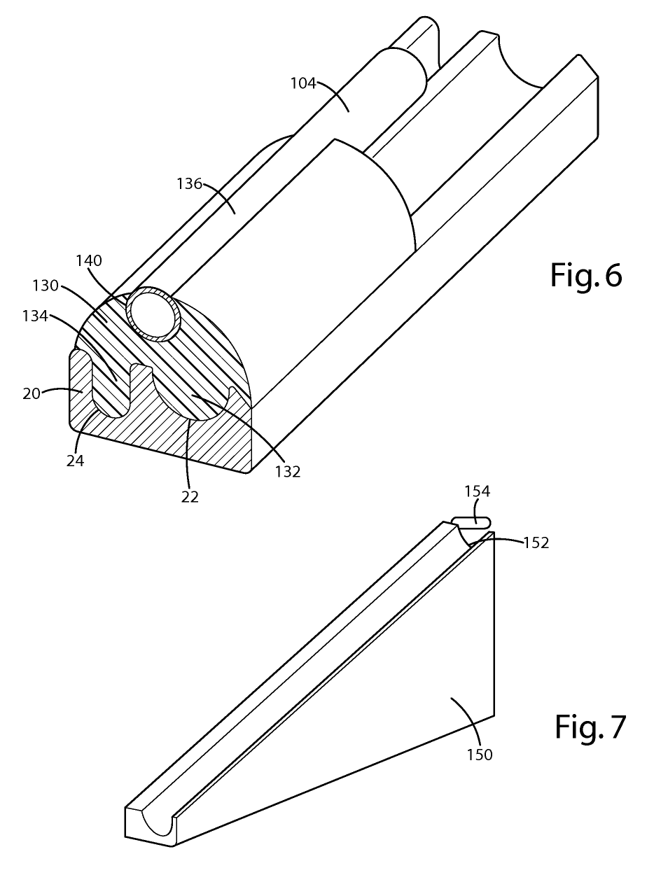

The stackable transport frame of the present disclosure provides an elegant, cost-effective, and relatively lightweight system to transport bulky, expensive items, particularly hospital stretchers. Referring to the drawings, and specifically FIG. 1, the stackable transport frame of the present disclosure includes a plurality of stackable tiers 10 (FIG. 5). Each of the tiers includes a pair of rails 20 held in fixed spaced parallel relationship with each other along the length of the transport frame. The rails, as best shown in FIG. 6, have a semicircular groove or channel 22 (FIG. 6) within which the wheels of the hospital stretcher may be received and the hospital stretcher rolled onto the tier 10. It should be noted, of course, that different sized and shaped wheels on the moveable hospital stretcher to be transported may call for rails 20 having different groove 22 configurations. Indeed, it might be appropriate in certain circumstances that the groove 22 be flat, due to a wheel on the hospital stretcher that might be square, to adequately receive the wheel in such a configuration. The rail 20 also is provided with a groove or channel 24 (FIG. 6) parallel with and alongside the groove 22 to provide added stiffness to the rail 20. The rail 20 may be fabricated from aluminum alloy, and in one embodiment is fabricated from 6063T6 aluminum alloy, and is extruded into approximately 7-foot lengths.

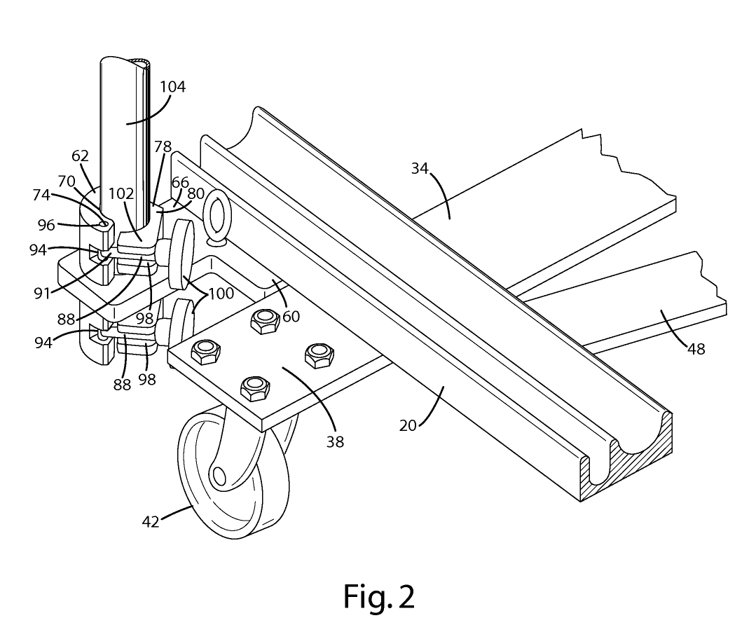

Referring now to FIGS. 4 and 5, the rails or support track 20 are maintained in spaced apart, parallel relationship by track supports 30, 32 (FIG. 1). Each of the track supports 30, 32 is attached at its distal end to the underside of the rail 20 by an appropriate welding technique. End supports 34, 36 (FIG. 1) are provided to the underside of the rail 20, closer to the distal end of the rail 20. Again, the end supports 34, 36 may be attached to the rail 20 through appropriate welding technology. As shown in FIG. 6, a portion 38 of each of the end supports 34 extends beyond the rail 20 and is provided with a plurality of apertures 40 to which a caster wheel assembly 42 (FIG. 2) may be attached in the event that tier 10 is situated as the bottom tier in the stackable assembly. The tier 10 is also provided with a long brace 46 and a pair of short braces 48, 50 attached diagonally between rails 20, each of which is situated between the respective track supports 32, 36 and end supports 34, 36 to provide additional structural stiffness to the tier 10. Again, these braces 46, 48, 50 are attached to the bottom of the rail 20 by an appropriate welding technique. All the supports 30, 32, 34, 36 and braces 46, 48, 50 are comprised of the same aluminum alloy as the rail 20.

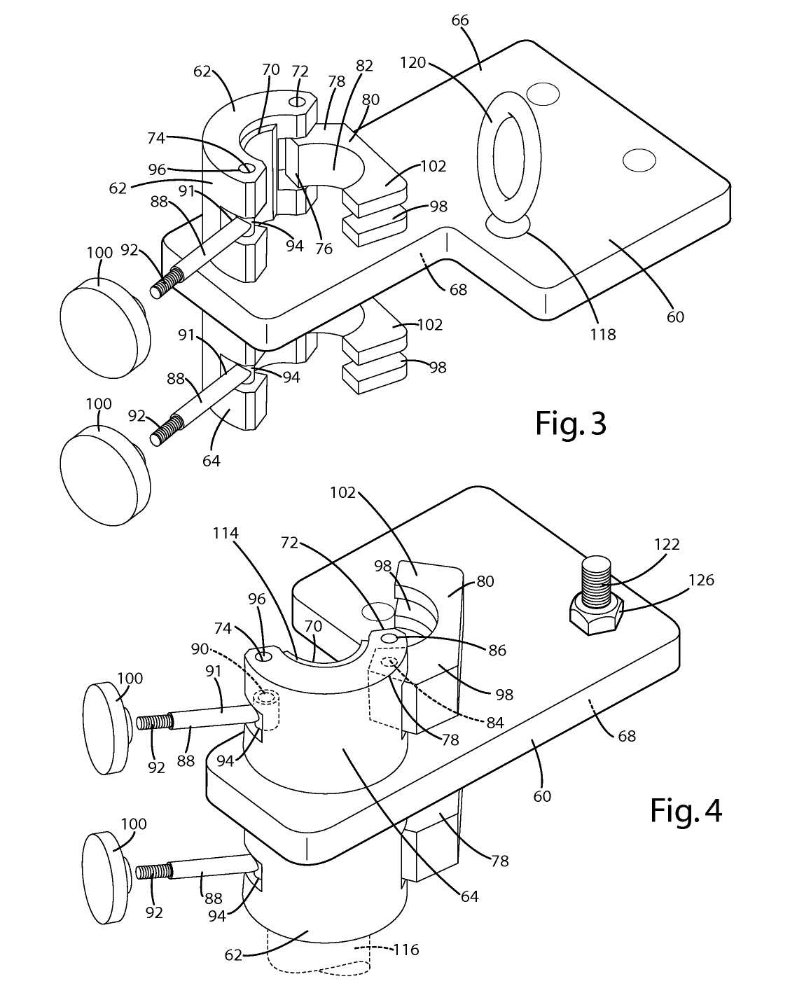

A coupling platform 60 (FIG. 5) is provided at each corner of each tier 10. As best shown in FIG. 6, the coupling platform 60 is welded to the underside of the rail 20 to which it is attached. Each of the coupling platforms 60 includes a cylindrical pair of opposed couplings 62, 64 (FIG. 3) projecting upwardly and downwardly with respect to the plane of the tier 10. Each of the couplings 62, 64 has a semicircular configuration. Coupling 62 extends upwardly above a surface 66 (FIG. 3) of the coupling platform 60, while coupling 64 extends downwardly from a bottom surface 68 (FIG. 3) of the coupling platform 60. In one embodiment, the coupling platform 60 includes the opposed couplings 62, 64 and are cast from a single casting in aluminum alloy. By virtue of the fact that the coupling platform 60 is a solid cast piece, it has been found that significant advantages can be obtained in comparison to pieces welded one to the other. The assembly is less expensive and, perhaps most importantly, it is stronger. Thus, the ability to cast the pair of opposed couplings 62, 64 as a single solid piece has been found to have significant advantages.

As illustrated in FIGS. 3 and 6, the opposed couplings 62, 64 are each provided with a hollow interior concave surface 70 into which a vertical support member 104 may be received, as discussed further below. The couplings 62, 64 are further each provided with a pair of vertically disposed machined holes 72, 74. The first vertical hole 72 is positioned through a notch 76 in each of the opposed couplings 62, 64. The notch 76 is adapted to receive a pivotable end 78 of a coupling lock 80. The coupling lock 80 also has a concave inner surface 82 matching the concave surface 70 of the couplings 62, 64 into which the vertical support member 104 is received, as will be discussed.

The coupling lock 80 has a pivot hole 84 at the pivotable end 78 of the coupling lock 80, which is inserted into the notch 76, whereby the pivot hole 84 is aligned with the vertical hole 72 in the opposed couplings 62, 64. Once in position, a pivot pin 86 is driven into the pivot hole 72 to pivotally secure the coupling lock 80 to each of the opposed couplings 62, 64. In one embodiment, a binding agent, such as LokTite, is disposed in the vertical hole 72 prior to assembly to permanently secure the pivot pin 86. The pivot pin 86 is slightly oversized and may be fabricated from a soft metal material, such as brass, and is press-fit into position. Pivot pin 86 is thus oversized with respect to the diameter of the pivot hole 72, however, it is undersized as to the diameter of the pivot hole 84 in the coupling lock 80 so as to allow the coupling lock 80 to freely pivot about the pivot pin 86.

Referring now to FIGS. 2 and 4, at the opposite side of the semicircular portion of opposed couplings 62, 64, there is provided a pivotable lock pin 88. Pivotable lock pin 88, which may be one half inch in diameter and fabricated from metal, is provided with a pivot hole 90 at one end 91 and a threaded portion 92 at an opposite end. The pivot end 91 is received within a notch 94 in each of the opposed couplings 62, 64 and pivotally secured thereto by aligning the lock pin pivot hole 90 with the vertical machined vertical hole 74 into which is inserted a pivot pin 96. Pivot pin 96, likewise, has a diameter slightly larger than that of the diameter of the vertical hole 74 so that it is press-fit into position and may also be similarly manufactured from a soft metal, such as brass. Again, a binding agent may be disposed in the vertical hole 74 prior to assembly. The pivot hole 90 of the lock pin 88, however, is sized sufficiently larger than the outer diameter of the lock pin 96 so as to allow the lock pin 88 to freely pivot within the notch 94.

The opposite end of the coupling lock 80 is provided with a lock notch 98 disposed perpendicular of the axis of pivot of the coupling lock 80. This can be best seen in FIGS. 2, 3, and 4. A threaded rotatable knob 100 is threadedly attached to the end 92 of the lock pin 88. As best shown in FIGS. 2, 3, and 4, the coupling lock 88 may be locked securely in position relative to each of the opposed couplers 62, 64 by pivoting the coupling lock 80 against the opposite end of the coupling 62, 64, then pivoting the lock pin 88 so as to allow the lock pin 88 to be received within the lock notch 98 of the coupling lock 80. The lock knob 100 is then rotated along the threaded end 92 of the lock pin 88 so that the lock knob 100 bears against an end 102 of the coupling lock 80 to firmly and securely lock the coupling lock 80 into position relative to the opposed couplings 62, 64. The locking knobs 100 may be fabricated from any number of different materials, including polymeric materials. However, it has been found that knobs fabricated from aluminum alloys tend to exhibit higher durability given the hostile environment within which the tiers 10 are typically subjected.

Each of the tiers 10 may be attached one to the other in stackable relationship by the addition of vertical support members 104. Vertical support members 104 are fabricated from hollow tubular aluminum stock fashioned to an appropriate length given the vertical height of the item to be transported. The vertical support members 104 have a diameter snuggly received within the resulting circular opening created by the assembly of the coupling lock 80 with the opposed couplings 62, 64, as shown in FIG. 3. Each of the vertical support members 104 positioned at each of the corners of the tier 10 is thus securely and rigidly received by one of the opposed couplings 62, 64 to rigidly secure the vertical support member 104 to a corner of tier 10 in a plane perpendicular to the plane of the tier 10.

As may be appreciated, the downwardly extending opposed couplings 64 of the adjacent tier, for example the tier above, is likewise attached at an opposite distal end of the vertical support member 104 to the upwardly extending opposed coupling 62 of the coupling member 104 of the tier 10 below. When all four corners of the tier 10 are assembled and locked into position, as shown in FIG. 1, the stackable tiers 10 are rigidly attached one to the other. The stacking of the various tiers 10 can continue so long as the weight and strength of the stackable transport frame maintains its integrity. For example, it is contemplated that three tiers 10 may be provided in a single assembly of a stackable transport frame for transporting three of the hospital stretchers at a time.

It is further contemplated that the rails 20, track supports 30, 32, and end supports 34, 36 of the stackable tier 10 may be replaced with an alternative load-bearing surface having an outer perimeter for carrying an item, such as a reinforced grate, plate, or other structure adapted to support the weight of the item to be shipped. In such circumstances, the plurality of coupling platforms 60 may be fixedly attached proximate and about the outer perimeter of the load bearing surface of each of the stackable tiers 10.

As noted previously, it may be desirable to provide the standard caster wheel assembly 42 at each corner of the bottom tier. By having each of the tiers 10 provided with the end supports 34, 36 that extend beyond the side of each of the rails 20, each tier 10 is capable of being provided with the caster wheel assembly 42. Also, in the illustrated embodiment, at least on one side of at least one of the rails 20, a pair of brake pads 106, 108 (FIG. 5) is provided, to which a pair of brake assemblies 110, 112 (FIG. 1) may be attached, to maintain the assembly 42 in place against unwanted movement. A further feature of the disclosure is that each of the tiers 10 is identical. The caster wheel assembly 42 and brakes 110, 112 can all be interchangeably adapted and affixed to each one of the tiers 10, as may be necessary.

In a further embodiment as shown in FIG. 4, the opposed couplings 62, 64 on each of the coupling platforms 60 may be further provided with a recess or socket 114 in the upwardly extending coupling 62 that is sized sufficiently large enough to receive a nipple 116 of the downwardly extending coupling 64 on the coupling platform 60 of the vertically adjacent tier 10 above. That is, when it is desirable to ship the unit back to the distribution center or factory from which it came without the stretcher in place, it is desirable to collapse the tiers 10 so that they consume less volume in the shipment process. Under such circumstances, it would be desirable to have a way of nesting the tiers 10 compactly one to the other. The nipple 116 provided on the downwardly extending coupling 64 is received within the recess or socket 114 of the upwardly extending coupling 62 of the adjacent tier 10. In order to secure the tiers 10 one to the other for transport back to the distribution center or factory, traditional VELCRO fasteners can be used to attach one rail 20 of a tier 10 to another rail 20 of another adjacent tier 10 to secure them together for transport. Alternatively, a significantly shortened version of the detachable vertical support members 104 may be used to lock the tiers 10 together so they may be shipped back to the factory.

Also, in one embodiment, each of the coupling platforms 62, 64 is provided with an aperture 118 into which is received a lifting ring 120 (FIG. 3) having a threaded end 122 (FIG. 4) received within an aperture in the coupling platform 62, 64. In one embodiment, a threaded fastener, such as a nut 126 (FIG. 4), is attached to the threaded end 122 after the lifting ring 120 is assembled into the aperture. The lifting rings 120 are positioned parallel to each of the rails 20, whereby the lifting ring 120 may be used to lift the tier 10 into and out of position with power assisted devices, as is known.

A further feature of the present disclosure is a polyurethane stop 130, as shown in FIG. 6, which is adapted to be snuggly received within each of the grooves 22, 24 through protrusions 132, 134, which are tightly received within the grooves 22, 24. An upper portion 136 of stop 130 can be positioned to engage the wheels of the stretcher during transport and prevent the stretcher from moving relative to the tier 10, in addition to standard methods of tying the hospital stretcher to the assembly during transport. The stop 130 is also provided with a nearly semi-circular concave recess 140 that is sized to closely conform to the outer diameter of the vertically extending member 104. When positioned on the rail 20, the stop 130 can be used to transport the extending members 104 by resiliently securing the extending members 104 to each of the rails 20 for transport back to the factory. That is, the extending member 104 may be snuggly received within the recess 140 as shown, with the stop 130 snuggly received within the grooves 22, 24 of the rail 20, so as to keep the vertical support member 104 with the appropriate tier 10 on the transport of the tier 10 back to the distribution center or factory.

It may also be desirable to provide a ramp 150 disposed to provide an interlock with each of the rails 20 so as to provide the ramp 150 into which the hospital stretcher may be loaded onto the tier 10, as shown in FIG. 7. For example, ramp 150 may have a groove 152 corresponding to and mating with groove 22 of the rail 20. A pin 154 may be disposed parallel to the groove 152 to be received within groove 24 of the rail so as to restrain the ramp 150 in position while the hospital stretcher is loaded onto tier 10. It can be readily imagined that a pair of such ramps 150 can be provided on either side so as to facilitate loading and unloading of at least the bottom tier.

The above description is considered that of the embodiments only. Modifications of the disclosure will occur to those skilled in the art and to those who make or use the invention. Therefore, it is understood that the embodiments shown in the drawings and described above are merely for illustrative purposes and not intended to limit the scope of the invention, which is defined by the following claims, as interpreted according to the principles of patent law, including the doctrine of equivalents.

1. A stackable transport frame comprising:
a plurality of stackable tiers comprises a pair of support tracks disposed in spaced parallel relation with each other and fixedly coupled by a plurality of track supports disposed substantially transversely to the longitudinal length of the support tracks;
a plurality of coupling platforms fixedly attached proximate an end of each support track of each of the stackable tiers such that each of the coupling platforms is disposed at a corner of the stackable tiers, each of the coupling platforms further comprising a pair of opposed couplings extending perpendicularly upwardly and downwardly relative to the plane of the stackable tier to which the coupling platform is attached; and
a plurality of detachable vertical support members, each of the couplings adapted to securely receive one of the plurality of detachable vertical support members so as to detachably lock one of the plurality vertical support members to the coupling platform in a perpendicular relation to the plane of the stackable tier, wherein one of the plurality of stackable tiers is stacked upon another of the plurality of stackable tiers to form a lower tier and an upper tier, the lower tier having one end of one of the plurality of vertical support members locked to each of the upwardly extending couplings of the coupling platform of the lower tier and the upper tier having an opposite end of one of the plurality of vertical support members locked to each of the downwardly extending couplings of the coupling platforms of the upper tier at each respective corner of the stackable tiers.

2. The stackable transport frame of claim 1, wherein the opposed couplings are each provided with a hollow interior concave surface into which one of the plurality of vertical support members may be received; and
each of opposed couplings are also provided with a first notch which pivotably receives a coupling lock having a concave inner surface matching the concave surface of the opposed couplings into which one of the plurality of vertical support members is rigidly received.

3. The stackable transport frame of claim 2, wherein the opposed couplings each have vertically disposed machined holes, wherein a first of the holes is positioned through the notch adapted to receive a pivotable end of a coupling lock; and
the coupling lock has a pivot hole at the pivot end of the coupling lock aligned with the first hole in the opposed couplings, wherein a pivot pin is fixedly inserted into the first hole in the opposed couplings to pivotally secure the coupling lock to each of the opposed couplings.

4. The stackable transport frame of claim 3, wherein a first pivot pin is press-fit into the first hole in the opposed couplings, the pivot pin being oversized with respect to the diameter of the first hole in the opposed coupling and undersized as to the diameter of the pivot hole in the coupling lock so as to allow the coupling lock to freely pivot about the first pivot pin.

5. The stackable transport frame of claim 4, wherein each of the opposed couplings is provided with a second notch, which pivotably receives a locking pin having a pivot hole within the second notch opposite the first notch, and wherein a second pivot pin is press-fit into a second of the holes in the opposed couplings, the second pivot pin being oversized with respect to the diameter of the second hole in the opposed coupling and undersized as to the diameter of the pivot hole in a pivotable locking pin so as to allow the coupling lock to freely pivot about the first pivot pin.

6. The stackable transport frame of claim 5, further comprising a lock knob, and wherein the pivoting locking pin has a threaded end, and wherein an end of the coupling lock opposite the pivotable end of a coupling lock is provided with a lock notch disposed perpendicular of the axis of pivot of the coupling lock, and whereby the coupling lock is locked securely in position relative to each of the opposed couplers by pivoting the coupling lock against an opposite end of the coupling, whereby the threaded end of the locking pin is received within the lock notch, and whereby the lock knob is then rotated along the threaded end of the lock pin so that the lock knob bears against an end of the coupling lock to firmly and securely lock the coupling lock into position relative to the opposed couplings and securely receive one end of the vertical support member.

7. The stackable transport frame of claim 1, wherein each of the pairs of support tracks is maintained in spaced parallel relation with each other and fixedly coupled by a plurality of braces disposed between the pair of track supports transverse to the longitudinal length of the support tracks.

8. The stackable transport frame of claim 7, wherein the plurality of braces disposed between the pair of track supports substantially diagonally to the longitudinal length of the support tracks includes a pair of end supports.

9. The stackable transport frame of claim 8, wherein the pair of end supports extends transversely beyond an outer edge of the track supports to form wheel mounts adapted to receive wheels.

10. The stackable transport frame of claim 1, wherein each of the tiers is provided with a brake pad mount adapted to receive an attached brake assembly.

11. The stackable transport frame of claim 1, wherein each of the coupling platforms is provided with a lifting hook.

12. A stackable transport frame for transporting items, the transport frame comprising:
an upper stackable tier and a lower stackable tier, each tier having a pair of support tracks disposed in spaced parallel relation with each other and coupled by a plurality of track supports attached substantially transversely to the longitudinal length of the support tracks;
a coupling platform fixedly attached proximate an end of each support track of each of the stackable tiers to form a corner of each of the stackable tiers, the coupling platforms further comprising a pair of opposed couplings extending perpendicularly upwardly and downwardly relative to the plane of the stackable tier to which the coupling platform is attached; and
vertical support members extending intermediate the corners of each of the upper and lower stackable tiers, the vertical support members detachably locked to one of the coupling platforms in a perpendicular relation to the plane of the stackable tier, wherein one of the plurality of stackable tiers is stacked upon another of the plurality of stackable tiers to form a lower tier and an upper tier, the lower tier having one end of one of the plurality of vertical support members locked to each of the upwardly extending couplings of the coupling platform of the lower tier and the upper tier having an opposite end of one of the plurality of vertical support members locked to each of the downwardly extending couplings of the coupling platforms of the upper tier at each respective corner of the stackable tiers.

13. The stackable transport frame of claim 12, wherein each of the support tracks has a groove along its longitudinal length.

14. The stackable transport frame of claim 13, wherein each of the support tracks has a second groove along its longitudinal length parallel to the first groove.

15. The stackable transport frame of claim 13, further comprising a resilient stop adapted to be snuggly received within the groove through a protrusion that is tightly received within the groove.

16. The stackable transport frame of claim 15, further comprising a semicircular concave recess sized to closely conform to the outer diameter of each of the plurality of vertically extending members, whereby one of the plurality of extending members is snuggly received within the recess, with the stop snuggly received within the groove of the rail so as to attach the one of the plurality of vertical support members to the tier during shipment.

17. The stackable transport frame of claim 15, wherein the stop is fabricated from polyurethane.

18. The stackable transport frame of claim 12, wherein the frame is fabricated from aluminum alloy.

19. A coupling platform for joining a plurality of stackable tiers comprises a load bearing surface having an outer perimeter for carrying an item;
a plurality of coupling platforms fixedly attached proximate the outer perimeter of the load bearing surface of each of the stackable tiers, each of the coupling platforms further comprising a pair of opposed couplings extending perpendicularly upwardly and downwardly relative to the plane of the stackable tier to which the coupling platform is attached; and
a plurality of a detachable vertical support member, each of the couplings adapted to securely receive one end of the plurality of detachable vertical support members so as to detachably lock one end of one of the plurality of vertical support members to the coupling platform in a perpendicular relation to the plane of the stackable tier, wherein one of the plurality of stackable tiers is stacked upon another of the plurality of stackable tiers to form a lower tier and an upper tier, the lower tier having one end of the vertical support members locked to the upwardly extending coupling of the coupling platform of the lower tier and the upper tier having an opposite end of one of the plurality of vertical support members locked to the downwardly extending coupling of the coupling platform of the upper tier.

20. The stackable transport frame of claim 19, wherein the opposed couplings are each provided with a hollow interior concave surface into which one of the plurality of vertical support members may be received;
each of the opposed couplings is also provided with a first notch which pivotably receives a coupling lock having a concave inner surface matching the concave surface of the opposed couplings into which one of the plurality of vertical support members is rigidly received;
each of the opposed couplings having vertically disposed machined holes, wherein a first of the holes is positioned through the notch adapted to receive a pivotable end of a coupling lock; and
the coupling lock having a pivot hole at a pivot end of the coupling lock aligned with the first hole in the opposed couplings, wherein a first pivot pin fixedly inserted into the first hole in the opposed couplings pivotally secures the coupling lock to each of the opposed couplings.

21. The stackable transport frame of claim 20, wherein the first pivot pin is press-fit into the first hole in the opposed couplings, the pivot pin being oversized with respect to the diameter of the first hole in the opposed coupling and undersized as to the diameter of the pivot hole in the coupling lock so as to allow the coupling lock to freely pivot about the first pivot pin; and
wherein each of opposed couplings is provided with a second notch, which pivotably receives a locking pin having a pivot hole within the second notch opposite the first notch, and wherein a second pivot pin is press-fit into a second of the holes in the opposed couplings, the second pivot pin being oversized with respect to the diameter of the second hole in the opposed coupling and undersized as to the diameter of the pivot hole in the locking pin so as to allow the locking pin to freely pivot about the second pivot pin.

22. The stackable transport frame of claim 21, further comprising a lock knob, the locking pin having a threaded end, and an end of the coupling lock opposite the pivotable end of a coupling lock having a lock notch disposed perpendicular of the axis of pivot of the coupling lock, and whereby the coupling lock is locked securely in position relative to each of the opposed couplers by pivoting the coupling lock against an opposite end of the coupling such that the threaded end of the locking pin is received within the lock notch and the lock knob is then rotated along the threaded end of the lock pin so that the lock knob bears against an end of the coupling lock to firmly and securely lock the coupling lock into position relative to the opposed couplings and securely lock one end of the vertical support member.

23. A stackable transport frame for transporting items, the transport frame comprising:
an upper stackable tier and a lower stackable tier;
a coupling platform fixedly attached proximate an edge of each of the stackable tier, the coupling platforms further comprising a pair of opposed couplings extending perpendicularly upwardly and downwardly relative to the plane of the stackable tier to which the coupling platform is attached;
the opposed couplings each having an interior surface into which one of a plurality of vertical support members may be received, and the opposed couplings each having a coupling lock pivotably attached thereto having an interior surface matching the interior surface of the opposed couplings to create an opening into which one of the plurality of vertical support members is rigidly received; and
the vertical support members extending intermediate an outer perimeter of each of the upper and lower stackable tiers and the vertical support members detachably locked to one of the coupling platforms in a perpendicular relation to the plane of the stackable tier, wherein one of the plurality of stackable tiers is stacked upon another of the plurality of stackable tiers to form the lower tier and the upper tier, the lower tier having one end of one of the plurality of vertical support members locked to each of the upwardly extending couplings of the coupling platforms of the lower tier and the upper tier having an opposite end of one of the plurality of vertical support members locked to each of the downwardly extending couplings of the coupling platforms of the upper tier of the stackable tiers.

24. The stackable transport frame of claim 23, wherein the coupling platform and the pair of opposed couplings are comprised of a single solid aluminum casting.
